(19) United States
(12) Patent Application Publication
(10) Pub. No.: US 2019/0050376 A1
(43) Pub. Date: Feb. 14, 2019

(54) AUTOMATIC VALUE FORMATTING BASED ON INTRINSIC STRUCTURAL SEMANTICS

(71) Applicant: SAP SE, Walldorf (DE)

(72) Inventors: Rouven Krebs, Ettlingen (DE); Steffen Koenig, Heidelberg (DE); Benjamin Hoke, Bad Schönborn (DE); Jochen Wilhelm, Sandhausen (DE); Christian Rost, Speyer (DE); Matthias Meissner, Mühlhausen (DE)

(21) Appl. No.: 15/673,691

(22) Filed: Aug. 10, 2017

(51) Int. Cl. G06F 17/21; G06F 17/27

(52) U.S. Cl. CPC G06F 17/211; G06F 17/241; G06F 17/2785

(57) ABSTRACT

Techniques are described for automatically analyzing received values to determine their semantic meaning and apply one or more formatting modifications and/or emphases to the received values based on the determined semantic meaning. In one example, a value to be formatted based on a semantic context associated with at least two portions of the received value is received. In response, a semantic rules associated with the received value is identified. The received value is semantically processed using the semantic rules, where processing includes identifying at least two portions of the value corresponding to their contexts. At least one formatting rule is determined as associated with the two or more semantic contexts, each formatting rule associated with a particular context. The formatting rules are applied to the corresponding portions of the received values associated their semantic contexts to generate a modified version of the received value, which is then provided for presentation.

### TECHNICAL FIELD

The present disclosure relates to techniques for automatically analyzing received values to determine their semantic meaning and apply one or more formatting modifications and/or emphases to the received values based on the determined semantic meaning.

### BACKGROUND

Usability and accessibility of data and software applications is not only a legal requirement, but also an important aspect for users' productivity and for providing a positive impact on an entity's image. Solutions for improved interactions in software and interactive presentations can assist various types of users, from novice or non-technical users, to expert programmers and administrators, to those with physical or mental challenges.

### SUMMARY

Implementations of the present disclosure are generally directed to automatically analyzing received values to determine their semantic meaning and apply one or more formatting modifications and/or emphases to the received values based on the determined semantic meaning. In one example implementation, a computerized method executed by hardware processors can be performed. The example method can comprise receiving a value to be formatted based on a semantic context associated with at least two portions of the received value. In response to receiving the value to be formatted, automatically and without user input, several operations are performed. At least one semantic rule associated with the received value is identified. The received value is then semantically processed using the at least one identified semantic rule, wherein semantically processing the received value comprises identifying at least two portions of the received value corresponding to two or more semantic contexts defined by the at least one semantic rule. At least one formatting rule is determined from a plurality of formatting rules associated with at least one of the two or more identified semantic contexts, each formatting rule of the plurality of formatting rules associated with a particular semantic context. Each of the at least one identified formatting rules are then applied to the at least two portions of the received value associated with the two or more identified semantic contexts to generate a modified version of the received value based on the at least one applied formatting rules. The modified version of the received value is then provided for presentation.

Implementations can optionally include one or more of the following features. In some instances, the received value is of a particular data type, where the at least one semantic rule is associated with the particular data type. In those instances, the method may further comprise, prior to identifying the at least one semantic rule associated with the received value, analyzing the received value to identify the particular data type of the received value. In some instances, the particular data type is one of a plurality of data types, where each of the plurality of data types is associated with a different set of semantic rules. In some instances, each particular data type is associated with a particular set of formatting rules. In some instances, analyzing the received value to identify the particular data type of the received value can include identifying metadata received from a calling entity associated with the received value, the metadata identifying the particular data type of the received value.

In some instances, the modified version of the received value comprises an image of a formatted version of the received value.

In some instances, the modified version of the received value comprises a formatted string with the at least one identified formatting rules applied to the corresponding at least two portions of the received value.

In some instances, the modified version of the received value includes metadata identifying each portion of the received value to be formatted and an identification of at least one formatting-related modification to be performed on each of the identified portions to be formatted. In those instances, the received value can be received from a calling application, wherein providing the modified version of the received value for presentation includes providing the received value and the metadata associated with the modified version of the received value to the calling application, and wherein the application of the formatting-related modifications included in the metadata are performed at runtime by the calling application.

In some instances, the received value comprises one of an International Standard Book Number (ISBN), a phone number, a social security number (SSN), a bank account number, an Internet Protocol version 6 (IPv6) address, a computer identification, and addressing or routing information.

Similar operations and processes may be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for analyzing received values to determine their semantic meaning and apply one or more formatting modifications associated with different portions of the received value based on those portions various semantic meanings.

FIG. 2 illustrates a portion of an example series of patterns used to analyze and evaluate the contents of an IPv6 address.

FIG. 3 is an example flowchart of a process for automatically analyzing received values to determine their semantic meaning and apply one or more formatting modifications and/or emphases to the received values based on the determined semantic meaning.

FIG. 4 illustrates an example modification of an IPv6 address to a modified version of the address in one implementation.

FIG. 5 illustrates an example modification of an ISBN number to a modified version of the ISBN number in one implementation.

FIG. 6 illustrates an example related to phone numbers being identified and additional semantic information and corresponding formatting being added in one implementation.

### DETAILED DESCRIPTION

The present disclosure relates to techniques for automatically analyzing received values to determine their semantic meaning and apply one or more formatting modifications and/or emphases to the received values based on the determined semantic meaning. Numbers and values can often contain digits and/or subparts with an additional or individual semantic meaning within the whole of the number or value. Usually this information is not required to fulfil its primary purpose for an end user, but may be important for a technical user or other system to provide the additional context that the information can provide. Well-known examples of such numbers or values may be a phone number. For example, a phone number such a 12145554545 can be dialed without any knowledge as to the semantic meaning of the individual subparts of the number. Someone administrating telephone systems may be interested in such semantic information, identifying “1” as the country code identifying the United States, “214” as the area code associated with the Dallas-Fort Worth metroplex, and “5554545” as the actual endpoint of the phone number. This information may be difficult to retrieve from the number in a manner that provides meaningful information to a user. Therefore, different styles of representing phone numbers has been established. For example, +1 214-555-4545 provides an easier to read number using the same information. With such information, however, manual translation may be required to increase the readability of the additional semantics.

In context of the IP/IPv6 addresses, such a standard semantic split and presentation of addresses has not yet been provided. An example IPv6 address may be 21ab:0db8:85a3:08d3:1319:8a2e:0370:7347. While the IPv6 address includes the character “:” to separate quadruples of hex-digits within the number, “:” is not related to the separation of an additional semantic. In case of an IPv4 address, this is acceptable due to the low complexity and the comparatively simple structural elements. However, in the much more complicated and detailed IPv6 number, the semantics behind particular portions of the IPv6 address are unclear. While the number itself may be used to access a particular resource, it is important for administrators and/or technical users to view the structure and semantic meaning of the individual digits or sets of digits providing semantic information within the value. In addition, the amount of digits reserved for a certain purpose may be variable and depends on the preceding portion, such as the prefix portions of the IPv6 address.

The present solution describes an example architecture and techniques for receiving particular values associated with any of a plurality of data types and, based on the particular data type, identify the particular semantic meaning of portions of the received value. One or more formatting rules can be associated with each of the semantic meaning types for a particular data type. Once the semantic meaning is determined for one or more of the particular portions of the received value, the formatting rule corresponding to the semantic meaning can be applied to the value and provided for presentation to a user interface (UI) or to a particular application which may in turn present the value in the formatted way. Formatting the number may include applying color, highlighting, underlying, annotation, separated presentation of the information, or any other suitable formatting. Example formatting of the numbers may include time-decoupled presentations (e.g., a first part shown immediately or initially, and a second part shown shortly thereafter (e.g., 2 seconds later)), a physical or haptic modification (e.g., Braille readers), a change in audio presentation (e.g., voice level, pitch, voice, etc.), a complete replacement of numbers or values by a verbal or written description, or any other suitable formatting options.

In general, the present disclosure provides a generic solution for how numbers and values having internal semantics can be analyzed and subsequently formatted for increased readability and understanding of the meaning of the numbers or values and their internal semantics. Formatting the values or otherwise changing their presentation can be performed by changing portions of the values (e.g., replacing the values with a description of the semantic information they represent, presenting the semantic meaning outside the values themselves, etc.), changing the visual appearance of the portions within the value itself (e.g., different coloring, formatting, or annotation), and/or presenting additional information about the portions outside of the value in an additional information field or presentation.

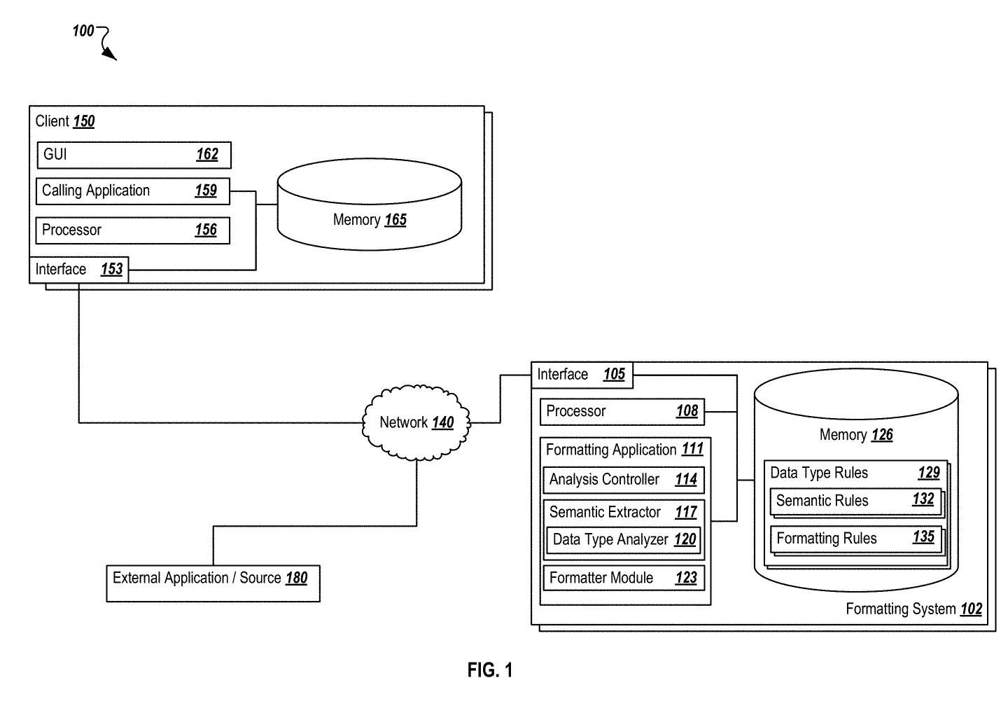

Turning to the illustrated implementation, FIG. 1 is a block diagram illustrating an example system 100 for analyzing received values to determine their semantic meaning and apply one or more formatting modifications associated with different portions of the received value based on those portions various semantic meanings. System 100 is a single example of a possible implementation, with alternatives, additions, and modifications possible for performing some or all of the described operations and functionality. As illustrated in FIG. 1, system 100 is associated with systems capable of sharing and communicating information across devices and systems (e.g., formatting system 102 and client 150) via network 140. Although components are shown individually, in some implementations, the functionality of two or more components, systems, or servers may be provided by a single component, system, or server. Further, additional components may be included in alternative implementations that perform at least a part of the functions of the illustrated components. For example, at least a portion of the components illustrated in formatting system 102 may be stored remotely from the system 102, or at another location accessible via network 140.

As used in the present disclosure, the term “computer” is intended to encompass any suitable processing device. For example, client 150 and formatting system 102 may be any computer or processing device such as, for example, a blade server, general-purpose personal computer (PC), Mac®, workstation, UNIX-based workstation, embedded system or any other suitable device. Moreover, although FIG. 1 illustrates particular components as a single element, those components may be implemented using a single system or more than those illustrated, as well as computers other than servers, including a server pool or variations that include distributed computing. In other words, the present disclosure contemplates computers other than general purpose computers, as well as computers without conventional operating systems. Client 150 may be any system which can request data, execute an application, and/or interact with the formatting system 102. The client 150, in some instances, may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, any real-time OS among others.

Formatting system 102 may be associated with the execution of one or more applications used to receive, analyze, and modify one or more particular values or numbers based on their semantic meaning. The formatting system 102 may receive requests from client 150 (e.g., via calling application 159) that include a particular number or value for formatting. The formatting system 102 includes a formatting application 111 that manages the operations associated with the formatting process. Once the operations are complete, the formatting system 102 can provide the client 150 with the responsive and appropriately formatted number or value. In some instances, in analyzing the number or value, the formatting system 102 may use information associated with one or more external applications or sources 180. That information may allow the formatting system 102 to better interpret the number or value and continue or complete the formatting process.

The formatting system 102 as illustrated includes an interface 105, a processor 108, a formatting application 111, and memory 126. Interface 105 is used by the system 102 for communicating with other systems in a distributed environment—including within the environment 100—connected to the formatting system 102 and/or network 140, e.g., clients 150, external applications, sources, or systems 180, as well as other systems communicably coupled to the network 140. Generally, the interface 105 comprises logic encoded in software and/or hardware in a suitable combination and operable to communicate with the network 140 and other communicably coupled components. More specifically, the interface 105 may comprise software supporting one or more communication protocols associated with communications such that the formatting system 102, network 140, and/or interface's hardware is operable to communicate physical signals within and outside of the illustrated environment 100.

Network 140 facilitates wireless or wireline communications between the components of the environment 100 (e.g., between the system 102 and the client 150, among others) as well as with any other local or remote computer, such as additional mobile devices, clients, servers, remotely executed or located portions of a particular component, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components (e.g., the system 102) may be included within network 140 as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n/ac, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

The system 102 also includes one or more processors 108. Although illustrated as a single processor 108 in FIG. 1, multiple processors may be used according to particular needs, desires, or particular implementations of the environment 100. Each processor 108 may be a central processing unit (CPU), an application specific integrated circuit (ASIC), a field-programmable gate array (FPGA), or another suitable component. Generally, the processor 108 executes instructions and manipulates data to perform the operations of the formatting system 102, in particular those related to executing the formatting application 111. Specifically, the processors 108 execute the algorithms and operations described in the illustrated figures, as well as the various software modules and functionality, including the functionality for sending communications to and receiving transmissions from clients 150, as well as to other devices and systems. Each processor 108 may have a single core or multiple cores, with each core available to host and execute an individual processing thread. In some instances, a cloud-based solution may use one or more remotely or otherwise available processors 108 and their cores to allow for further operations and optimization of operations via parallel processing. As noted, the processor 108 executes the operations of and those associated with the formatting system 102, particularly in executing the formatting application 111.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

The formatting application 111 may be any application, framework, agent, or other software capable of managing the operations of the value or number formatting as described herein. In some instances, the formatting application 111 may include one or more sub-modules, agents, or software that includes an analysis controller 114, a semantic extractor 117, and a formatter module 123. These components may be distinct subparts of the formatting application 111, remotely executed agents or software, and/or functionality inherent to the formatting application 111, as suitable for different implementations.

The analysis controller 114 receives, identifies, and/or retrieves the request from a particular calling application 159 with regard to the formatting of a particular number or value. The analysis controller 114 can manage the formatting process by forwarding the number or value to be formatted to the appropriate components, such as the semantic extractor 117 and the formatter module 123. In particular, the analysis controller 114 can initially provide the value to the semantic extractor 117. When the semantic extractor 117 returns a set of information providing the particular semantic information associated with the value, the analysis controller 114 can provide that semantic information along with the value to the formatter module 123 to have the value perform the value's transformation. In response to receiving the formatted value from the formatter module 123, the analysis controller 114 can then, via interface 105, return the formatted value to the calling application 159.

The semantic extractor 117 performs the semantic analysis of the value as received from the analysis controller 114. The particular semantic analysis of the value may depend on the data type of the particular value. In some instances, the semantic extractor 117 may include a data type analyzer 120. The data type analyzer 120 can evaluate the received value to determine the data type of the value. For example, the data type may be an IPv6 address, an ISBN number for a book, a financial account, or any other suitable data type. In such instances, the request may include metadata, embedded information, or another indicator identifying a particular type of value provided. The data type analyzer 120 may interpret this information to identify a particular data type rule set 129 corresponding to the data type of the value. In other instances, the data type analyzer 120 may apply a determination algorithm to identify the particular data type based on the value itself, such as by using one or more data type determination rules (not shown) based on the format and/or syntax, or any other intrinsic information, associated with the value. Alternatively, the receipt of the value from a particular source may provide the data type analyzer 120 with the information to determine the data type. For example, if the value is received from a first application associated with a library or bookseller, the formatting application 111 can know that the formatting is associated with an ISBN number and proceed accordingly. Any other suitable knowledge or indications can be used to determine the appropriate data type. In some instances, the formatting system 102 may be associated with a single application or set of values, such that only one data type is formatted using the described process. In such instances, the determination of the data type may be unnecessary as the type is known prior to receipt. Once the data type is determined or identified, the corresponding data types rules 129 can be identified an applied. In some systems, the correct formatting type may be automatically retrieved (i.e., without user input or request) by an analysis of the input where the input is not originally known before the information is received or identified.

The semantic extractor 117 can use the semantic definitions 132 of the data type rules 129 to parse the received value and identify specific semantic meanings within the value. In some instances, the semantic extractor 117 can call external applications or data sources 180 for additional information needed to derive the semantic information. These external sources 180 may provide additional context to specific information obtained from the analyzed value. For example, if a portion of the value is known to be a provider portion of an IPv6 address, the particular provider can be searched and identified by the semantic extractor 117 using an external source 180 (e.g., a telecomm provider). In another example of an ISBN value, a portion of the value can include a publisher identifier. The semantic extractor 117 can access the external source(s) 180 to identify the particular publisher corresponding to the embedded publisher identifier to provide the additional context information to the user.

In some instances, the semantic extractor 117 may be associated with or make use of a state machine performing multiple considerations on each portion of a received value. The state machine may be operated using one or more semantic rules 132. In some instances, the value may be analyzed by traversing a path of states, where each transition is guarded by a pattern identifying the next semantic block or portion of the value. This pattern can be based, in some instances, on RFCs, standards, heuristics, defined tables, or globally available registries. The guards may also be adjusted automatically and/or defined by an external source 180 delivering additional information. The structure of the semantics within the received value differ based on the data type being worked on, as well as the specific portions of the particular value received.

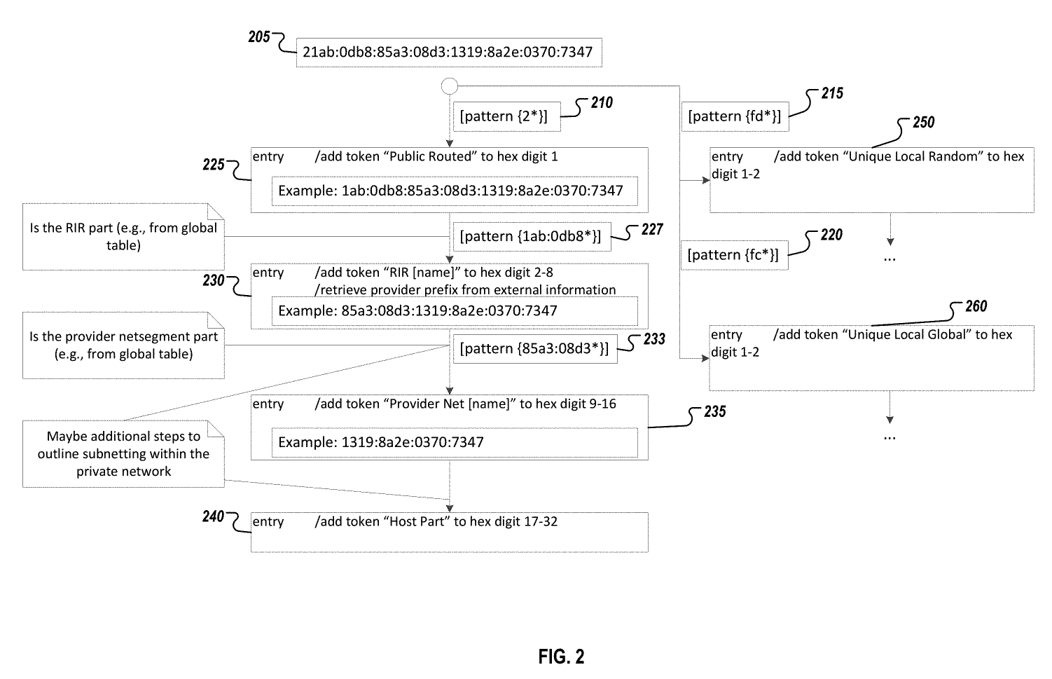

FIG. 2 illustrates a portion of an example series of patterns used to analyze and evaluate the contents of an IPv6 address. In each state, the IPv6 address removes the previous portion of the value that has decided a prior token or component of the received value, and evaluates the next portion moving forward. These guards allow the individual portions of the address to be evaluated based on that which was already analyzed.

The previous IPv6 address example, 21ab:0db8:85a3:08d3:1319:8a2e:0370:7347, is used again as the starting point 205 in the illustrated example. In the first state of the machine, a determination of three (3) potential opening patterns is made. The starting pattern may be “2*” 210, where “*” represents a wild card value, “fd*” 215, or “fc*” 220. Depending on the initial determination of the starting pattern, the analysis may follow very different paths. As the starting values of the example address 205 begin with “2*”, the state machine will follow pattern {2*} 210 and assign the semantic values according to this path. If the beginning pattern was {fd*} 215, then the machine would continue with operations 250 and additional further operations (not shown). Alternatively, if the beginning pattern of the value 205 was {fc*} 220, then the machine would continue with operations 260.

Upon determining that the starting value matches the pattern 210, at 225 a new semantic token is associated with hex digit 1, indicating that “1” in the IPv6 address 205 is a “Public Routed” address. Since the first digit is associated with the semantic token “Public Routed”, later formatting operations can be used to modify the presentation of the particular portion of the value 205 to identify or indicate its meaning. Once the particular portion of the IPv6 address has been considered, the string is updated to remove the already considered value and continue in its pattern matching and identification. The remaining portion of the address is then “1ab:0db8:85a3:08d3:1319:8a2e:0370:7347.” One or more patterns can be evaluated at this point in the process. As illustrated, only a single pattern is showed specific to the current remaining value, where the pattern {1ab:0db8*} 227 is evaluated. At 230, then, a semantic token “RIR [name]” is associated with hex digits 2-8. The token may be parameterized and potentially used for more complex formatting in other instances. The RIR name defines a particular regional Internet registry (RIR), that is, the organization that manages the allocation and registration of Internet number resources within a particular region of the world. The particular RIR IP ranges or externally defined patterns (e.g., 1ab:0db8) may be obtained from an external source 180. That determined prefix can be returned once the analysis is complete. Once the determination of the RIR part (e.g., from a global table) is made, the remaining value of the address is “85a3:08d3:1319:8a2e:0370:7347”.

Using another pattern 233 of {85a3:08d3*}, the semantic extractor 117 can determine that those digits—i.e., hex digits 9-16—should be associated with a token identifying the values as “Provider Net [name]” or “Provider NetSegment [name]” part at 235. The specific Provider matching that portion of the value can be determined by accessing a global table including a listing of some or all of the providers associated with the identified RIR. The portion “[name]” represents an optional parameter added to the token that may make the representation even more sophisticated, such as by adding complete other substrings including additional information or data. In some instances, the semantic extractor 117 may access an external source 180 to identify the particular Provider.

The remaining portion of the address is then “1319:8a2e:0370:7347”. Based on the rule set, the remaining portion (i.e., hex digits 17-32) is identified as the “Host Part” of the IPv6 address, and can be associated with a token identifying that portion as such at 240.

Once the entirety of the value is analyzed using the semantic extractor 117, the value along with the various tokens (or an indication of the associated tokens and digit values or locations) can be returned for formatting based on the associated semantics determined during this analysis.

Returning to FIG. 1, the formatting rules 135 associated with the data type can be accessed and applied by the formatter module 123. The formatter module 123 can receive or otherwise obtain the output of the semantic extractor 117 (e.g., via the analysis controller 114), where portions of the received value are associated with particular internal semantics and, in some cases, additional information. The formatter module 123 applies the data type-specific formatting rules 135 to apply different visualizations and modifications to the received value as correspond to the particular portions. The result of the formatter module's 123 operations is a formatted string, figure, or complex object describing how the received value is to be presented at the calling application 159. Any suitable output of the formatting process can be used, including a specifically formatted value, a set of metadata or associated file or data defining how the original value should be modified (i.e., where the calling application 159 then modifies the presentation based on this description or data), or any other suitable information that allows the original value to be formatted appropriately. In some instances, particular portions of the received value may be formatted a particular color, may be formatted with a particular emphasis (e.g., italics, underlining, bolding, highlighting, different size font, etc.), may be annotated with additional information or include additional information to be provided with or in conjunction with the presentation of the original value, may be translated to match the underlying semantic values represented by a particular substring in the original value, or any other suitable formatting. In the example associated with the IPv6 determination, the original value may be returned along with an identified digit or digits, a display name for annotating the value, and a color for presentation of the particular portion. For example, the following information may be provided for a portion of the IPv6 address:

Digit 1: Display Name=“Public Routed IP”, Color=Blue

Digit 2-8: Display Name=“Regional Internet Region”, Color=Red

. . .

In alternative response, a formatted response, an image, or other complex object(s) connecting and/or presenting the different parts or portions of the received value may be provided instead of the instructions on how the value should be formatted. Any suitable responsive value can be provided by the formatter module 123

Once the formatter module 123 generates the output of the formatting process, the analysis controller 114 can return the formatted value and/or information about how the formatted value should be presented back to the calling application 159.

In some instances, the various components of the formatting application 111 may be associated with defined interfaces for inputs to their respective processes and outputs related to the results of their actions. For example, the analysis controller 114 may include an INumberFormatter interface, where the received value can be taken as input. The output of the INumberFormatter interface can be a formatting number as a string (e.g., containing non-numeric characters), an image, or a complex structure describing how the received original value should be presented by the calling application 159. The semantic extractor 117 may be associated with an IExtractor interface, where the input is the received value (e.g., as provided by the analysis controller 114), and where the output comprises additional semantic information associated with the original value and the particular digits within the original value with which they are associated. The formatter module 123 may include an IFormatter interface, which receives inputs of the value and the additional semantic information (e.g., the output of the IExtractor interface). The output of the IFormatter interface is then the formatted number as a string, an image, or any other suitable complex structure defining or describing how the value should be presented. This can be passed to the INumberFormatter interface in some cases, which can then forward or otherwise provide the IFormatter interface output as the result of the process back to the calling application 159.

As illustrated, the data type rules 129 are stored in memory 126. Memory 126 may represent a single memory or multiple memories. The memory 126 may include any memory or database module and may take the form of volatile or non-volatile memory including, without limitation, magnetic media, optical media, random access memory (RAM), read-only memory (ROM), removable media, or any other suitable local or remote memory component. The memory 126 may store various objects or data (e.g., the data type rules 129, among others), including financial data, user information, administrative settings, password information, caches, applications, backup data, repositories storing business and/or dynamic information, and any other appropriate information associated with the formatting system 102 including any parameters, variables, algorithms, instructions, rules, constraints, or references thereto. Additionally, the memory 126 may store any other appropriate data, such as VPN applications, firmware logs and policies, firewall policies, a security or access log, print or other reporting files, as well as others.

As illustrated, one or more clients 150 may be present in the example system 100. Each client 150 may be associated with one or more calling applications 159 that request a formatted version of a particular value via the formatting system 102. As illustrated, the client 150 may include an interface 153 for communication (similar to or different from interface 105), a processor 156 (similar to or different from processor 108), the calling application 159, memory 165 (similar to or different from memory 126), and a graphical user interface (GUI) 162.

The illustrated client 150 is intended to encompass any computing device such as a desktop computer, laptop/notebook computer, mobile device, smartphone, personal data assistant (PDA), tablet computing device, one or more processors within these devices, a virtual client associated with a cloud-based network or process, or any other suitable processing device. In general, the client 150 and its components may be adapted to execute any operating system, including Linux, UNIX, Windows, Mac OS®, Java™, Android™, or iOS. In some instances, the client 150 may comprise a computer that includes an input device, such as a keypad, touch screen, or other device(s) that can interact with the calling application 159, and an output device that conveys information associated with the operation of the applications and their application windows to the user of the client 150. Such information may include digital data, visual information, or a GUI 162, as shown with respect to the client 150. Specifically, the client 150 may be any computing device operable to communicate values for formatting to the formatting system 102, as well as communicate with one or more other clients 150, and/or other components via network 140, as well as with the network 140 itself, using a wireline or wireless connection. In general, client 150 comprises an electronic computer device operable to receive, transmit, process, and store any appropriate data associated with the environment 100 of FIG. 1.

GUI 162 of the client 150 interfaces with at least a portion of the environment 100 for any suitable purpose, including generating a visual representation of the calling application 159, which in turn can present at least a portion of a formatted value modified via the formatting system 102. In particular, the GUI 162 may be used to present results of the formatting process as received from the formatting system 102. GUI 162 may also be used to view and interact with various Web pages, applications, and Web services located local or external to the client 150. Generally, the GUI 162 provides the user with an efficient and user-friendly presentation of data provided by or communicated within the system. The GUI 162 may comprise a plurality of customizable frames or views having interactive fields, pull-down lists, and buttons operated by the user. For example, the GUI 162 may provide interactive elements that allow a user to view or interact with information related to the operations of processes associated with the formatting system 102. In general, the GUI 162 is often configurable, supports a combination of tables and graphs (bar, line, pie, status dials, etc.), and is able to build real-time portals, application windows, and presentations. Therefore, the GUI 162 contemplates any suitable graphical user interface, such as a combination of a generic web browser, a web-enable application, intelligent engine, and command line interface (CLI) that processes information in the platform and efficiently presents the results to the user visually.

In general, calling application 159 may be any application capable of requesting a formatting process to be performed on a particular value or number. In the illustrated example, calling application 159 may be a web browser, mobile application, cloud-based application, or dedicated remote application or software capable of interacting with the formatting system 102 via network 140 to request and subsequently present the result of a semantic analysis and formatting process executed by the formatting system 102. The request may be a core function of the calling application 159 or it may be a small piece of the calling application's overall functionality. In some instances, the calling application 159 may provide additional information along with the request, including an indication of the particular data type being sent that is separate from the value or number itself, thereby providing an explicit indication of the data type. In some cases, the calling application 159 may point to, communicate with, or transmit signals/communication to one or more external data sources to be used, such as but not limited to those external data sources identifying any preferred formatting styles or granularity of the semantic analysis. Furthermore, nonfunctional requirements may be provided by the calling application 159, for example, a max processing time or expected confidence of the returned result (e.g., in case the exact analysis may be not complete, some heuristics regarding the confidence in the determination may be appropriate with less accurate results, such that the calling application 159 can evaluate whether to use the result received based on that confidence level).

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

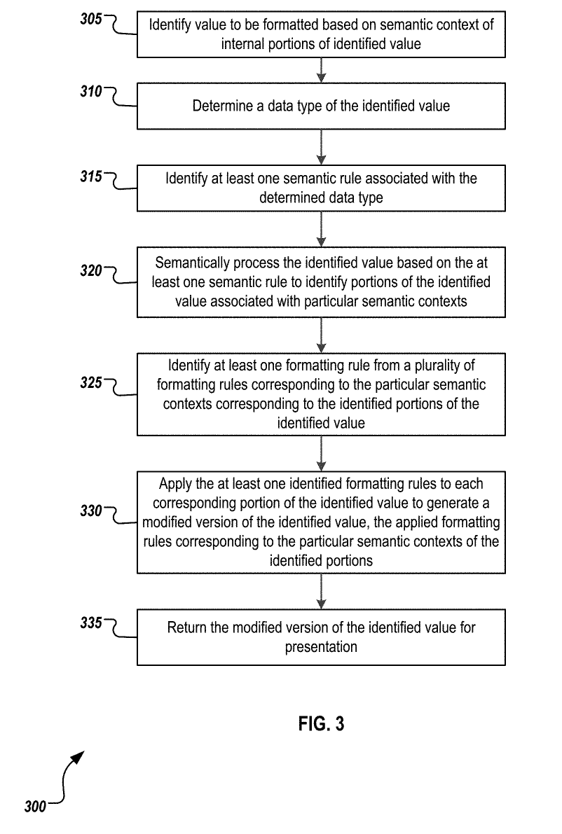

FIG. 3 is an example flowchart of a process 300 for automatically analyzing received values to determine their semantic meaning and apply one or more formatting modifications and/or emphases to the received values based on the determined semantic meaning. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate.

At 305, a value to be formatted based on the semantic context of one or more internal portions of the identified value is identified. The value may be any suitable value, including but not limited to, an IPv6 address, an ISBN number, a bank account, a financial account, a phone number, personal identification numbers (e.g., Social Security numbers, passport numbers, etc.), tax identification numbers, or any other suitable values. In some instances, the value may be a number or the value may be a string including one or more non-numerical values (e.g., colons, dashes, letters, etc.). The value may be identified in response to a request from a calling system or application, where the value is to be formatted at a formatting system or application.

At 310, a data type of the identified value is determined. In some instances, an initial analysis of the intrinsic format of the identified value may be used to identify the data type, including a pattern-matching analysis or other suitable determination. In other instances, the identified value may be associated with a request for formatting, where the request includes or the value is associated with additional extrinsic information or metadata identification or capable of being used to identify the particular type of data to be formatted. In other instances, the source of the request may be used to identify a particular data type. For example, a first request origination system may identify a particular value as an IPv6 address, while a second request origination system may identify a particular value as a different type of value, such as a bank account or other suitable data type.

Once the data type is determined, at least one semantic rule associated with the determined data type is identified at 315. The at least one semantic rule may define a pattern-based definition or state machine of how a particular data type is to be analyzed in order to provide a semantic extraction of the one or more portions within the identified value. In other instances, a semantic rule set identifying how particular data types are created and/or defined may be used. At 320, the identified value is semantically processed based on the at least one identified semantic rule to identify one or more portions of the identified value that have particular semantic contexts or meanings. The semantic context may identify a particular portion of the identified value as providing specific information or an identifier that encodes additional information, such as a source or explanation of the identified value. For example, an IPv6 address may include information about whether the address is public or private, a particular regional Internet registry (RIR) associated with the address, a set of provider information associated with the request, and a private portion identifying the particular location or endpoint of the address, among others. Similarly, other values may also encode or include indications for similar information within the value itself. In performing the semantic analysis, the system can identify particular digits or portions within the identified value that are associated with or define a particular semantic value or meaning outside the numbers or characters included in the identified value. Each of these portions may be associated with a token or other definition (e.g., in metadata associated with the value) that can identify the particular digits/characters corresponding to a particular semantic meaning as well as what the semantic information means. In some instances, a sequential analysis of the particular digits/characters in the identified value may be needed in order to allow initial semantic determinations to affect the following semantic determinations within the identified value. In other instances, the semantic analysis may be independent of the sequential digits/characters of the value (e.g., where the digits/characters in the value are at known locations in each instance of the data type), such that the semantic analysis may be performed concurrently on each of the known portions of the value. Still further, in addition to identifying a generic semantic meaning or association for portions of the value, additional external information may be obtained and included in the semantic analysis. For example, if a particular portion is identified as a Provider of a service, the particular digits/characters included in the particular portion can be used to identify from a database the actual name of the provider as opposed to the numerical identifier. That information can then be returned and included in the semantic information for further formatting and/or information.

At 325, the semantic information and digit/characters associated with that information are used to identify at least one formatting rule from a plurality of formatting rules. In some instances, the formatting rules may be specific to a particular data type. In others, similar formatting rules may be applied to any particular semantic meaning or semantic type across different data types. For example, if the semantic meaning of “Publisher” is present in multiple data types, the formatting rules may be applied consistently for all data types when the meaning of “Publisher” is returned. Alternatively, each data type may be associated with its own formatting rules to provide unique visualizations for each data type.

At 330, the at least one identified formatting rules are applied to each of the corresponding portions of the identified value to generate a modified version of the identified value. The formatting rules are applied to match the particular determined semantic contexts of the identified portions. In some instances, generating the modified version of the identified value generates an updated string with the one or more formatting changes applied. In other instances, generating the modified version may instead generate an image or visual file where the applied modifications have been made. In still other instances, a set of information specifically defining or describing the modifications to be made to the identified value is generated, where the formatting changes are applied at runtime. In these cases, a calling application may perform the formatting changes at runtime as opposed to the system determining the particular modifications to be made. In addition to specific changes to the identified value, one or more of the semantic meaning portions may be presented apart from or in a different view then the received value when presented. In some instances, one or more annotations may be associated with the modified version of the value to allow additional textual context to be visible to users. Different types of modifications may include the removal of internal symbols or placeholders (e.g., removal of a semi-colon, colon, or dash from a received value), emphasis of particular portions of the received value (e.g., color changes, underlining, bolding, highlighting, change in letter case, italicizing, etc.), the addition of callouts of particular portions of the identified value, or any other suitable modification.

At 335, the modified version of the identified value is returned for presentation at the calling system or application. In some instances, the calling system or application may be physically or logically remote from the system performing the semantic analysis and formatting determinations. In some instances, portions of the identified value may not be modified, such as when those portions represent a generic value or a value not associated with a particular semantic meaning relevant to the calling application or users interacting with the calling application or system.

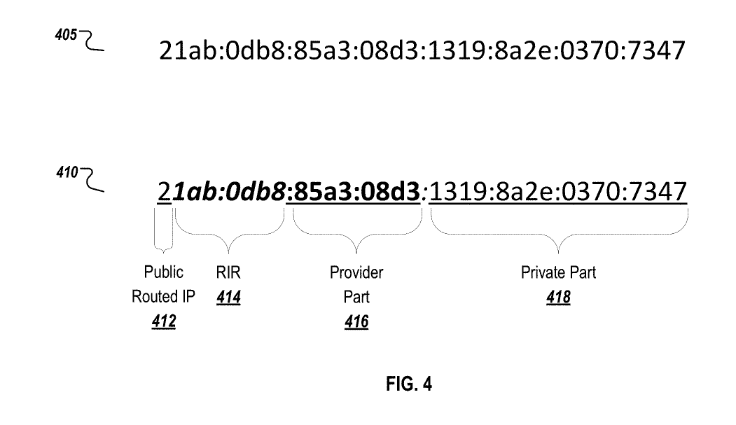

FIG. 4 illustrates an example modification to an IPv6 address 405 to a modified version of the address 410 using the techniques described herein. While illustrated as textual changes to the emphasis, any other suitable changes or modifications to the IPv6 address may be presented, along with other information providing additional information to users. As the address is semantically analyzed, four different portions —412, 414, 416, and 418—within the address are identified based on the semantic rules associated with the data type of IPv6 addresses. As illustrated, a determination is made that portion 412 corresponds to an indication that the IP address is publically routed. A further determination is that a second portion 414 composed of digits 2-8 of the address 405 relate to the RIR. In some instances, the particular RIR may be determined and included in the modified version of the value. Here, the indication that those digits correspond to the RIR is presented. A third determination as to third portion 416 indicates that digits 9-16 relate to the particular provider part of the address. Again, the particular provider may be determined using global tables and/or search queries, although the present illustration does not include that information. Finally, a fourth determination for the fourth portion 418 indicates the portion of the address as the private portion, or endpoint of the address. Each of these semantic meanings is associated with a particular formatting rule in the present example, with the first portion 412 being underlined and associated with the annotation “Public Routed IP”. The second portion 414 is bolded and italicized and associated with the annotation “RIR”. The third portion 416 is bolded and underlined and is associated with the annotation “Provider Part.” The fourth portion 418 is underlined and associated with the annotation “Private Part.”

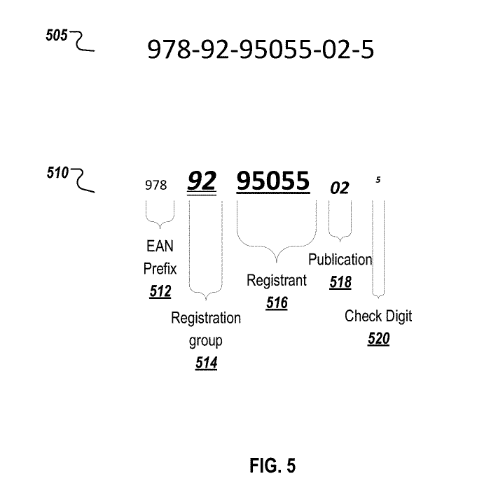

FIG. 5 illustrates an example modification to an ISBN number 505 to a modified version 510. Again, alternative modifications and formatting may be applied in other implementations. The ISBN number 505 is semantically analyzed to identify the different portions of the ISBN number. The ISBN number represents an International Standard Book Number. The standard ISBN values comprise five (5) elements, a prefix element, a registration group element, a registrant element, a publication element, and a check digit. The prefix element is currently limited, and may not be of significant interest to users. Here, the prefix element 512 is shown with a reduced size and no emphasis based on the semantic rules associated with ISBN numbers. The registration group element identifies a particular country, geographical region, or language area participating in the ISBN system that is associated with this particular entry. As shown, the registration group element 514 is emphasized with a bold, italicized, and double-underlined formatting in a relatively larger text than the prefix element 512. The registrant element 516 identifies the particular publisher or imprint, and is illustrated as a bolded and single underlined element. The publication element 518 identifies a particular edition and format of a specific title, and is presented in a bold but subscript formatting as per the formatting rules associated with publication elements. Finally, the check digit 520 is a final single digit used to mathematically validate the rest of the numbers in the ISBN number. As the value is not important to a user's understanding of the number, the element 520 value is a smaller font and in a superscript location. In some instances, non-relevant information may be removed from the modified version, where desired.

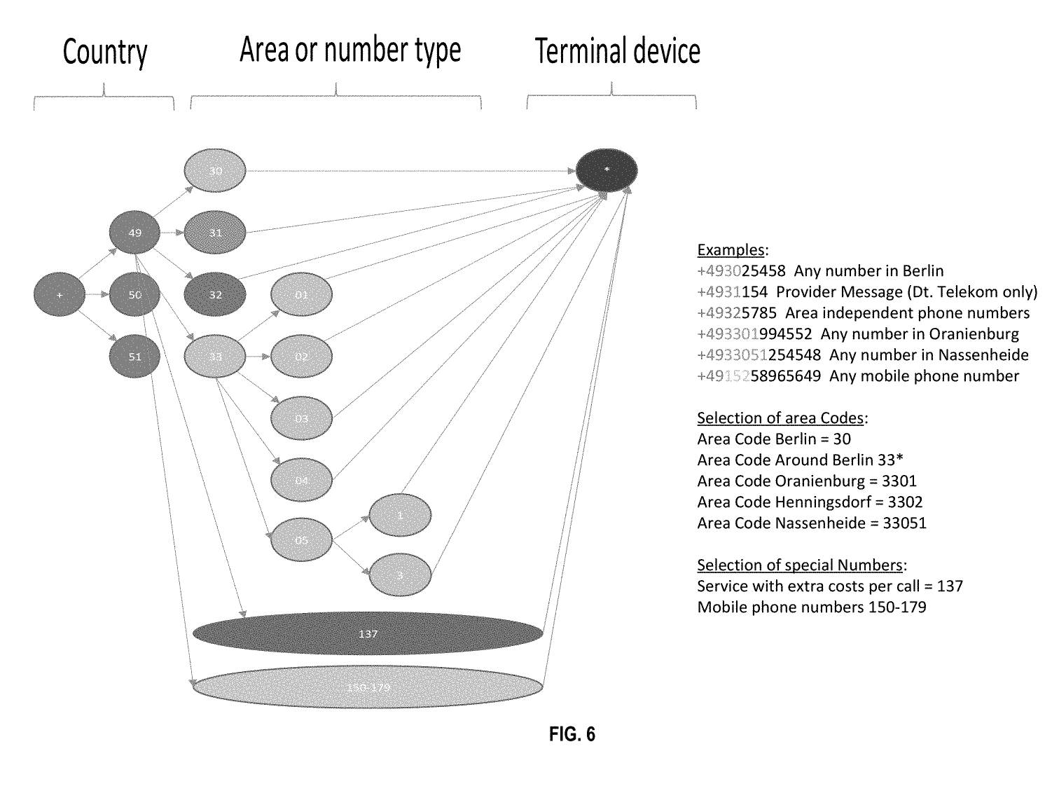

FIG. 6 provides an example related to phone numbers being identified and additional semantic information being provided by an implementation of the described processes. As illustrated, a phone number may be associated with a country code, an area code or number type, and a terminal device or endpoint number. The states shown in FIG. 6 present the sequential analysis of a particular telephone number and how the semantic extractor can evaluate and process the value. The phone number may begin with a “+”, which indicates a country code is beginning. The next numbers can be evaluated to determine a particular country associated with the phone number. In some instances, one, two, or additional numbers may be used or associated with the country code. In the illustrated portion, three different country codes are shown, “49”, “50”, and “51”. The further states associated with country code “49” are provided here (a portion thereof), although the full set of states may include numerous additional possibilities.

Once the country code has been determined, the pattern-based analysis continues to identify an area code or number type. As illustrated in the legend, some area code/number type values may be limited to two (2) numbers, while others include three (3), four (4), or five (5) values. For example, if the pattern of the next two numbers matches {30*}, then a determination is made that the number originates or is associated with a number in Berlin. If the pattern for the next two numbers matches {31*}, then a determination is made that the number is associated with a provider message from Deutsche Telekom. Similarly, a pattern of {32*} is known to be associated with area independent phone numbers. Should the next two numbers match a pattern of {33*}, however, additional determinations for the area or number type may need to be made, as some area codes include three (3) or more digits. Based on the known patterns of the phone numbers, a semantic extractor can determine the portions associated with the area code or number type and assign those digits as associated with the particular semantic meaning, both that they represent the area or number code and the information they represent. Once the area code or number is determined, the rest of the digits are known to be associated with the particular terminal device or endpoint.

Once the digits are identified with a particular semantic meaning, the format associated with those semantic meanings can then be applied to the values. In some instances such as those illustrated, the formatting for a particular type of semantic meaning (e.g., area or number type) may differ based on the particular information defined by the semantic information. For example, the area code digits associated with a number in Berlin may be formatted green, while area code digits associated with a mobile number area code may be formatted yellow. By changing the formatting for the specific semantic information, and not just the category of information, the system and operations can provide specific meaning to users interacting with the values, allowing for immediate understanding not just of the separation the different portions and a general type of data represented by the digits or portions within a particular value, but also the actual meaning of those digits or portions.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method performed by one or more processors, the method comprising:
receiving a value to be formatted based on a semantic context associated with at least two portions of the received value;
in response to receiving the value to be formatted, automatically and without user input:
identifying at least one semantic rule associated with the received value;
semantically processing the received value using the at least one identified semantic rule, wherein semantically processing the received value comprises identifying at least two portions of the received value corresponding to two or more semantic contexts defined by the at least one semantic rule;
determining at least one formatting rule from a plurality of formatting rules associated with at least one of the two or more identified semantic contexts, each formatting rule of the plurality of formatting rules associated with a particular semantic context;
applying each of the at least one identified formatting rules to the at least two portions of the received value associated with the two or more identified semantic contexts to generate a modified version of the received value based on the at least one applied formatting rules; and
providing the modified version of the received value for presentation.

2. The method of claim 1, wherein the received value is of a particular data type, and wherein the at least one semantic rule is associated with the particular data type.

3. The method of claim 2, further comprising, prior to identifying the at least one semantic rule associated with the received value, analyzing the received value to identify the particular data type of the received value.

4. The method of claim 3, wherein the particular data type is one of a plurality of data types, and wherein each of the plurality of data types is associated with a different set of semantic rules.

5. The method of claim 4, where each particular data type is associated with a particular set of formatting rules.

6. The method of claim 3, wherein analyzing the received value to identify the particular data type of the received value includes identifying metadata received from a calling entity associated with the received value, the metadata identifying the particular data type of the received value.

7. The method of claim 1, wherein the modified version of the received value comprises an image of a formatted version of the received value.

8. The method of claim 1, wherein the modified version of the received value comprises a formatted string with the at least one identified formatting rules applied to the corresponding at least two portions of the received value.

9. The method of claim 1, wherein the modified version of the received value includes metadata identifying each portion of the received value to be formatted and an identification of at least one formatting-related modification to be performed on each of the identified portions to be formatted.

10. The method of claim 9, wherein the received value is received from a calling application, wherein providing the modified version of the received value for presentation includes providing the received value and the metadata associated with the modified version of the received value to the calling application, and wherein the application of the formatting-related modifications included in the metadata are performed at runtime by the calling application.

11. The method of claim 1, wherein the received value comprises one of an International Standard Book Number (ISBN), a phone number, a social security number (SSN), a bank account number, an Internet Protocol version 6 (IPv6) address, a computer identification, and addressing or routing information.

12. A system comprising:
at least one processor; and
a memory communicatively coupled to the at least one processor, the memory storing instructions which, when executed, cause the at least one processor to perform operations comprising:
receiving a value to be formatted based on a semantic context associated with at least two portions of the received value;
in response to receiving the value to be formatted, automatically and without user input:
identifying at least one semantic rule associated with the received value;
semantically processing the received value using the at least one identified semantic rule, wherein semantically processing the received value comprises identifying at least two portions of the received value corresponding to two or more semantic contexts defined by the at least one semantic rule;
determining at least one formatting rule from a plurality of formatting rules associated with at least one of the two or more identified semantic contexts, each formatting rule of the plurality of formatting rules associated with a particular semantic context;
applying each of the at least one identified formatting rules to the at least two portions of the received value associated with the two or more identified semantic contexts to generate a modified version of the received value based on the at least one applied formatting rules; and
providing the modified version of the received value for presentation.

13. The system of claim 12, wherein the received value is of a particular data type, and wherein the at least one semantic rule is associated with the particular data type.

14. The system of claim 13, the operations further comprising, prior to identifying the at least one semantic rule associated with the received value, analyzing the received value to identify the particular data type of the received value.

15. The system of claim 14, wherein the particular data type is one of a plurality of data types, and wherein each of the plurality of data types is associated with a different set of semantic rules, and where each particular data type is associated with a particular set of formatting rules, and wherein analyzing the received value to identify the particular data type of the received value includes identifying metadata received from a calling entity associated with the received value, the metadata identifying the particular data type of the received value.

16. The system of claim 12, wherein the modified version of the received value comprises a formatted string with the at least one identified formatting rules applied to the corresponding at least two portions of the received value.

17. The system of claim 12, wherein the modified version of the received value includes metadata identifying each portion of the received value to be formatted and an identification of at least one formatting-related modification to be performed on each of the identified portions to be formatted, wherein the received value is received from a calling application, wherein providing the modified version of the received value for presentation includes providing the received value and the metadata associated with the modified version of the received value to the calling application, and wherein the application of the formatting-related modifications included in the metadata are performed at runtime by the calling application.

18. A non-transitory computer-readable medium storing instructions which, when executed, cause at least one processor to perform operations comprising:
receiving a value to be formatted based on a semantic context associated with at least two portions of the received value;
in response to receiving the value to be formatted, automatically and without user input:
identifying at least one semantic rule associated with the received value;
semantically processing the received value using the at least one identified semantic rule, wherein semantically processing the received value comprises identifying at least two portions of the received value corresponding to two or more semantic contexts defined by the at least one semantic rule;
determining at least one formatting rule from a plurality of formatting rules associated with at least one of the two or more identified semantic contexts, each formatting rule of the plurality of formatting rules associated with a particular semantic context;
applying each of the at least one identified formatting rules to the at least two portions of the received value associated with the two or more identified semantic contexts to generate a modified version of the received value based on the at least one applied formatting rules; and
providing the modified version of the received value for presentation.

19. The computer-readable medium of claim 18, wherein the received value is of a particular data type, and wherein the at least one semantic rule is associated with the particular data type, the operations further comprising, prior to identifying the at least one semantic rule associated with the received value, analyzing the received value to identify the particular data type of the received value.

20. The computer-readable medium of claim 19, wherein the particular data type is one of a plurality of data types, and wherein each of the plurality of data types is associated with a different set of semantic rules, and where each particular data type is associated with a particular set of formatting rules, and wherein analyzing the received value to identify the particular data type of the received value includes identifying metadata received from a calling entity associated with the received value, the metadata identifying the particular data type of the received value.
